(19) United States
(12) Patent Application Publication
(10) Pub. No.: US 2018/0127324 A1
(43) Pub. Date: May 10, 2018

(54) Reperation and usage method of chive flowers regulatory element

(71) Applicant: Yuanhui Fu, Chino Hills, CA (US)

(72) Inventor: Yuanhui Fu, Chino Hills, CA (US)

(21) Appl. No.: 15/348,264

(22) Filed: Nov. 10, 2016

(51) Int. Cl. C05F 11/00; A01G 1/00; A01C 21/00

(52) U.S. Cl. CPC C05F 11/00; A01C 21/007; A01G 1/001

(57) ABSTRACT

A preparation and usage method of chive flowers regulatory element comprising: wrap the chive flowers deprived of partial water with an animal bladder; place the wrapped chive flowers into soil and dig it out after a winter; store it into an insulating container and leave it in a shaded place; grind it into powders; mix it with water and spray it around plant roots.

### TECHNICAL FIELD

This invention is about soil and plant nutrition preparation technique, specifically, Preparation and Usage Method of Chive Flowers Regulatory Element.

### BACKGROUND OF THE INVENTION

At this time, the agriculture industry still mainly uses chemical fertilizers to improve plants production volume. But due to an excessive usage of chemical fertilizers, the productivity of soil is declining. Seen from people's health perspective, the agricultural products grown due to a usage of chemical fertilizers are less and less favorable.

This invention is based on biodynamic basis and the regulatory element is made of all natural materials turned into fertilizer through fermentation. This type of invention has been long proved to be reliable and is deemed as having met the top standards of biodynamic agriculture.

Description: this invention pertains to a preparation and usage of Chive Flowers regulatory element, which will help plants grow without harmful consequences.

This invention is processed and completed in the following ways:

Use animal bladder wrapper for Chive Flowers that have been rid off partial water; Put the wrapped Chive Flowers into soil and keep it there for a winter; Dig out the wrapped Chive Flowers and put them into an insulating glass or gallipot container and store the container in a shaded place.

Further, the said animal bladder is male horse or deer bladder; the insulating container can be either glass or gallipot.

Further, the said Chive Flowers are product of organic planting.

Further, the said Chive Flowers with partial water are ones deprived of 30%-70% of the original water from the Chive Flowers.

Further, the step of a burial of the wrapped Chive Flowers into soil over a winter can also be substituted with a process conducted inside a room with controlled temperatures: the whole process is divided into four stages: 1). The room temperature is set between 15-20° C. and this stage is two month long ; 2). The second stage is to control the room temperature between 0-15° C. for a time of 2 months; 3). The temperature is controlled at −30-0° C. for the length of one month; 4). The storage temperature is maintained between 0-10° C. for two months long.

This invention also publicizes a Chive Flowers regulatory element produced according to the above methods.

This invention also publicizes the usage methods of the Chive Flowers regulatory element, which includes the following steps:

1). Grind the wrapped Chive Flowers into powders;

2). Mix the powders with water (purified, distilled, or rain) with ratio 0.1-0.2 g/L;

3). Stir the powders evenly and then spray it around plant roots at a ratio 35-60 L/666.67 square meters.

Further, the water for the powders mixture is rain water, purified water or distilled water. Further, the usage method also includes an even stirring of the said regulatory element. Further, the stirring speed of the said regulatory element is 50-120 r/min, and alter the stirring direction every 0.5-5 min.; the length of stirring time is between 60-70 min.

The benefits of this invention are to improve soil fertilization and spur the growth of plants without harmful side effects.

The embodiments of the invention in which an exclusive property or privilege is claimed are defined as follows:

1. A preparation of chive flowers regulatory element comprising: use animal bladder to wrap chive flowers that is deprived of partial water and then bury it into soil and then dig it out after a winter, store it in an insulating container and place it in a shaded place.

2. A usage method of the chive flowers regulatory element recited in claim 1 is characterized by the following steps: grind the wrapped chive flowers into powders; mix the powders with water (purified, distilled, or rain) with ratio 0.1-0.2 g/L; stir the mixture evenly and spray it around plant roots at a ratio 35-60 L/666.67 square meters.
